(19) United States
(12) Patent Application Publication
(10) Pub. No.: US 2016/0314533 A1
(43) Pub. Date: Oct. 27, 2016

(54) SYSTEM FOR RESOURCE ALLOCATION ASSESSMENT AND ELECTRONIC COMMUNICATION

(71) Applicant: BANK OF AMERICA CORPORATION, Charlotte, NC (US)

(72) Inventor: William E. Brown, III, Morganville, NJ (US)

(21) Appl. No.: 15/048,374

(22) Filed: Feb. 19, 2016

Related U.S. Application Data
(63) Continuation of application No. 13/918,082, filed on Jun. 14, 2013, now abandoned.

(51) Int. Cl. G06Q 40/06; G06Q 40/04

(52) U.S. Cl. CPC G06Q 40/06; G06Q 40/04

(57) ABSTRACT

Embodiments of the invention provide for systems, computer program products, and methods for a resource usage and allocation wellness tool that provides an overview of the well-being of resource allocation plan participants based on whether or not they are exhibiting behaviors in the resource allocation plan that may lead to success. The resource usage and allocation wellness tool creates a wellness score for plan participants based on the behaviors of the participants. The resource allocation plan wellness tool provides a report to an institution that shows aggregated wellness scores and aggregated metrics illustrating the well-being of plan participants based on the participants that utilize an advice service, trends of the plan participates over time, and comparisons against plan participants of other institutions.

### FIELD OF THE INVENTION

The invention relates to a system for assessing the use and allocation of resources of clients, and the electronic communication of assessments.

### BACKGROUND

Monitoring and analyzing clients' resource allocation with specialized tools and effectively communicating assessments of the resource allocation allows a client to improve their overall resource allocation.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for a financial plan wellness tool (otherwise described herein as a financial wellness tool or financial wellness scoring tool) that provides an overview of the financial well-being of plan participates (e.g., employees of an institution participating in a retirement plan, clients of an institution participating in a retirement plan, or the like) based on whether or not the plan participates are exhibiting behaviors in the financial plan that may lead to retirement planning success. The financial plan wellness tool provides a report to an institution that shows financial plan wellness sources of the plan participants, and financial plan wellness metrics illustrating trends of plan participates over time and comparisons against the aggregate metrics of other plan participates (e.g., other plan participants at other institutions). Systems, computer program products, and methods are also described herein for a wellness segmentation tool (otherwise described herein as a wellness query tool) that may be a part of the financial wellness tool or may otherwise be a separate tool. The wellness segmentation tool allows a user 4 to create customized wellness segmentation reports in order to segment the wellness metrics of plan participants in one or more retirement accounts into customized groups for additional analysis.

Embodiments of the invention comprise systems, computer program products, and methods of a tool that identifies retirement account information for plan participants in a retirement account at an institution, wherein the retirement account information is related to savings, investing, setting and monitoring goals, and account preservation behaviors of the plan participants. The tool then determines a wellness score for the plan participants in the retirement account for the institution based on the retirement information, wherein the wellness score is determined from the retirement account information related to a measure of the savings, investing, setting and monitoring goals, and account preservation behaviors of the plan participants. The tool determines wellness metrics for the plan participants, wherein the wellness metrics reflect the wellness scores or the behaviors of the plan participants in one or more aggregate metrics. The tool then creates a report illustrating the wellness scores for the plan participants and the wellness metrics for the plan participants, and provides the report to desired parties.

In further accord with an embodiment of the invention, the savings behavior is determined based on behavior factors relating to a determination if the plan participants have an active status in the retirement account and are not contributing to the retirement account, a determination if the plan participants are contributing less than a contribution percentage, and a determination if the plan participants are not achieving the maximum benefit of contribution matching from the institution.

In another embodiment of the invention, the investing behavior is determined based on behavior factors relating to a determination if the plan participants are concentrated in the institution stock, a determination if the plan participants are concentrated in a specific asset class, and a determination if the plan participants are improperly using predefined diversified retirement allocations.

In still another embodiment of the invention, the setting and monitoring goals behavior is determined based on a behavior factor related to a determination of if the plan participants have requested an investment strategy.

In yet another embodiment of the invention, the account preservation behavior is determined based on a behavior factor related to a determination of if the plan participants are using a specified value of the retirement account balance as collateral for a loan.

In another embodiment of the invention, the wellness metrics for the plan participants are broken down into the plan participants that utilize an advice service and the plan participants that fail to use the advice service.

In further accord with an embodiment of the invention, the wellness metrics for the plan participants are broken down into age groups of the plan participants.

In still another embodiment of the invention, the wellness metrics for the plan participants are broken down as the wellness scores change over time; and in comparison with the wellness scores of other plan participants at other institutions.

In yet another embodiment of the invention, the wellness score is based on an initial value of ten points and the points are subtracted from the initial value based on behavioral factors of plan participants determined from the retirement account information.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a high level process flow of a financial wellness method, in accordance with one embodiment of the invention;

FIG. 2 illustrates a block diagram of a financial wellness system environment, in accordance with an embodiment of the invention;

FIG. 3 illustrates a process flow of a financial wellness method, in accordance with one embodiment of the invention;

FIG. 4 illustrates a wellness scoring table illustrating the participant behaviors, factors for the behaviors, scores for the factors, and weights for the behaviors used to calculate a financial wellness score, in accordance with one embodiment of the invention;

FIG. 5 illustrates a financial wellness report interface, in accordance with an embodiment of the invention;

FIG. 6 illustrates a financial wellness report interface, in accordance with an embodiment of the invention;

FIG. 7 illustrates a financial wellness report interface, in accordance with an embodiment of the invention;

FIG. 8 illustrates a financial wellness report interface, in accordance with an embodiment of the invention;

FIG. 9 illustrates a financial wellness report interface, in accordance with an embodiment of the invention;

FIG. 10 illustrates a financial wellness report interface, in accordance with an embodiment of the invention;

FIG. 11 illustrates a financial wellness report interface, in accordance with an embodiment of the invention;

FIG. 12 illustrates a wellness query tool process, in accordance with an embodiment of the invention;

FIG. 13 illustrates a customized report plan selector interface, in accordance with an embodiment of the invention;

FIG. 14 illustrates a customized report selection criteria interface, in accordance with an embodiment of the invention; and

FIG. 15 illustrates a customized report data point selection interface, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Thus, methods, systems, computer programs, and the like, are herein disclosed that provide for a financial plan wellness tool (otherwise described herein as a financial wellness tool or financial wellness scoring tool), that allows a user at an institution (i.e., business, non-profit, organization, or other like institution) to identify, monitor, and track the financial plan wellness of plan participants (e.g., employees, customers, or the like) in financial retirement account plans (e.g., individual retirement accounts (“IRAs”), 401K retirement accounts, self-directed retirement accounts, or the like) for the institution or for other institutions. Specifically, in one embodiment of the invention the methods, systems, and computer programs allow an institution to identify, monitor, and track the financial plan wellness of the institution's employees that participate in a 401K plan provided by the institution. As such, an institution may monitor the financial plan wellness of its own plan participants or in other embodiments another institution may monitor the plan participants for the institution and provide the institution a report. For example, in one embodiment, a financial institution may monitor the financial plan wellness of employees of a business that is a client of the financial institution. Furthermore, the financial plan wellness of the participants may be provided to the institution in a report through an interface, in an electronic report, in a paper report, or through another like channel.

Some embodiments of the invention also comprise a wellness segmentation tool (otherwise described herein as a wellness query tool) that may be a part of the financial wellness tool or may otherwise be a separate tool. The wellness segmentation tool allows a user 4 to create customized wellness segmentation reports in order to segment the wellness metrics of plan participants in one or more retirement accounts into customized groups for additional analysis. The wellness segmentation tool is described in further detail later.

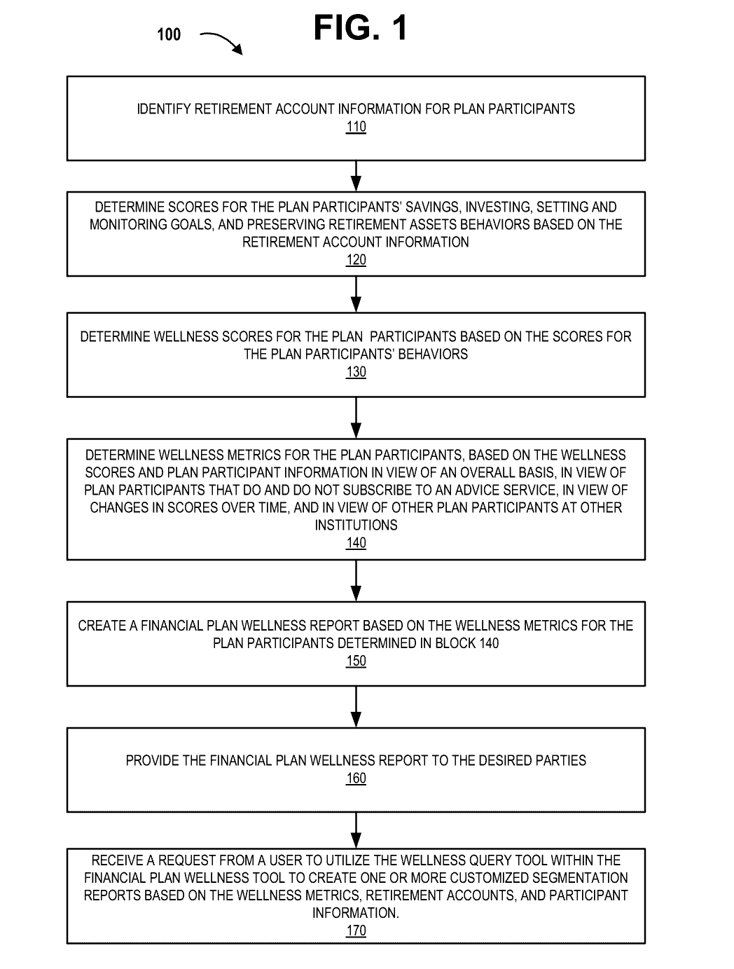

FIG. 1 illustrates a high level process flow for a financial plan wellness method 100. As illustrated by block 110 in FIG. 1, an institution identifies retirement account information for one or more of the participates in a retirement account. For example, in one embodiment a financial institution may identify 401K account information for the employees of client for which financial institution manages the 401K retirement account plan.

As illustrated by block 120 in FIG. 1, the institution determines scores for the savings, investing, setting and monitoring goals, and preserving retirement assets behaviors of the plan participants. The scores are based on the retirement account information identified for the one or more participants. For example, as discussed in further detail later, in one embodiment a financial institution may calculate scores for each of these factors based on the how the employees of the client invest in, and use, the 401K plan and other benefits provided by the client to the employees.

As illustrated by block 130 in FIG. 1, the institution determines a financial plan wellness score for one or more of the plan participants of the retirement account based on the scores determined in block 130. For example, in one embodiment the financial institution weights the scores for the behaviors, or behavior factors, and combines them to provide a single financial plan wellness score for each of the employees of the client that participate in the client's 401K plan that is managed by the financial institution.

As illustrated by block 140 in FIG. 1, the institution determines wellness metrics for one or more plan participants for one or more clients based, at least, on the financial plan wellness scores and participant information of one or more participants. The wellness metrics may be based on the wellness scores of plan participants on an overall basis within a single institution, in view of plan participants that utilize an advice service, in view of changes in wellness scores over time, as well as in view other plan participants at other institutions, or other like metrics. For example, as discussed in further detail later, in one embodiment the financial institution determines metrics that illustrate how the wellness scores and behavior factor scores of one or more participants in a client 401K plan relate to each other within a single institution, relate to each other based on the use of an advice service, change over time, and relate to scores of participants at other clients. The wellness metrics may also be broken down by the age of the plan participants.

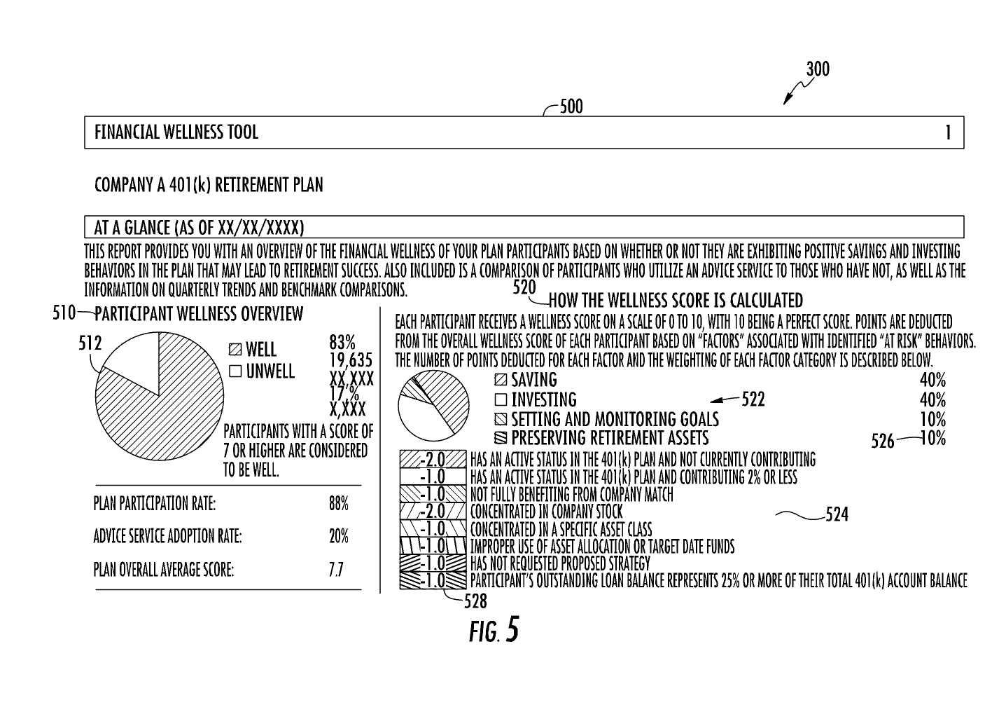

As illustrated by block 150 in FIG. 1, the institution creates a financial plan wellness report based on the wellness metrics determine from block 140. For example, as discussed in further detail with respect to FIGS. 5 through 11, in one embodiment the financial institution creates a report that may be viewed by the client to illustrate the financial retirement account wellness of the employees of the client over a period of time and in view of the financial retirement account wellness of the other employees of other clients.

As illustrated by block 160 in FIG. 1, the institution makes the reports available to the desired parties. For example, in one embodiment the financial institution provides the report to the client electronically.

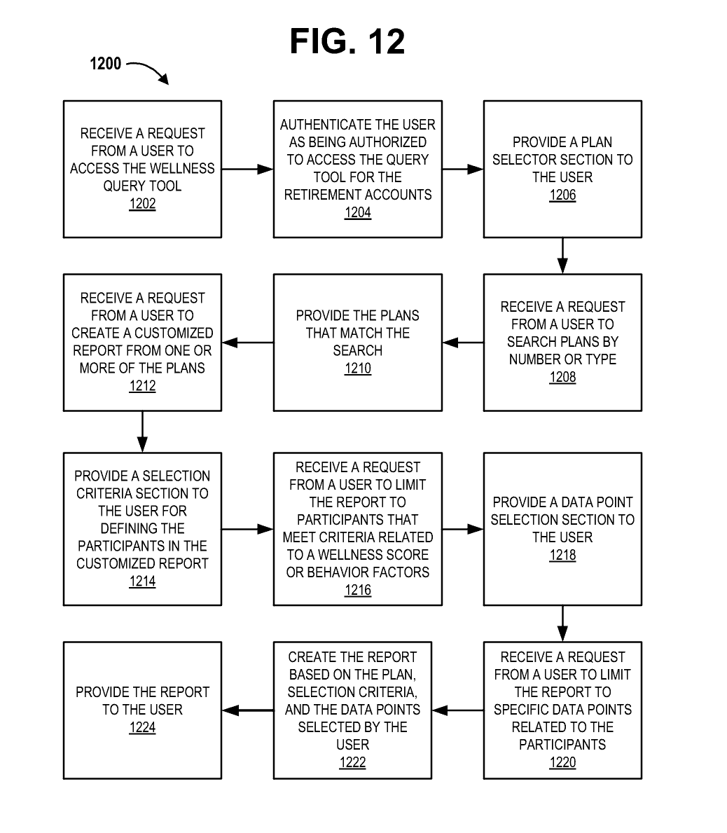

Block 170 in FIG. 1 further illustrates that the financial wellness scoring tool may also include a wellness segmentation tool (or wellness query tool). In other embodiments of the invention the wellness query tool may only be partially related to the financial wellness scoring tool, or otherwise, be a separate tool apart from the financial wellness scoring tool. Regardless of the relationship between the tools, the tools may work in conjunction with each other. A user 4 may utilize the wellness query tool to create one or more customized segmentation reports based on the wellness metrics, retirement accounts, and participant information. The wellness query tool is illustrated and described in further detail with respect to FIGS. 12 through 15 and the associated sections of the specification.

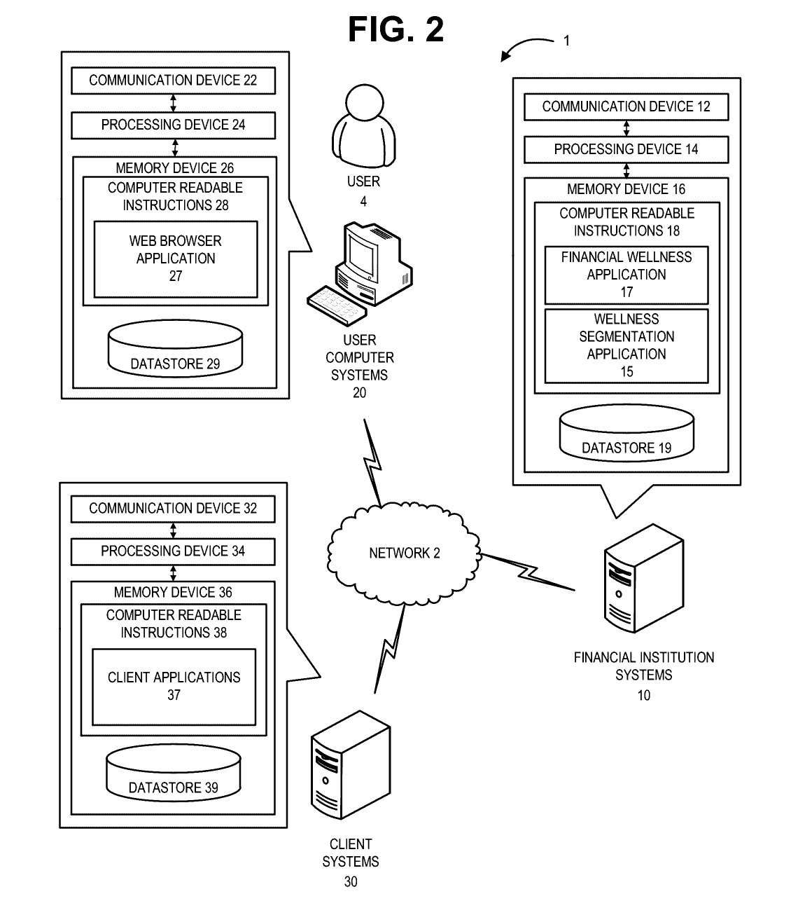

FIG. 2 illustrates a financial plan wellness system environment 1, in accordance with an embodiment of the present invention. As illustrated in FIG. 2, one or more financial institution systems 10 are operatively coupled, via a network 2, to user computer systems 20, and one or more client systems 30. In this way one or more users 4 at the client business may utilize the user computer systems 20 to view the financial plan wellness report created by the financial wellness application 17, or the customized wellness report created by the wellness segmentation application 15, using the financial retirement account information received from the financial institution systems 10 or the client systems 30. In some embodiments of the invention the financial institution systems 10 may host retirement account applications for the client, and thus, the financial institution may access its own financial institution systems 10 that host the client retirement account information in order to create the financial plan wellness report. In other embodiments of the invention the retirement account applications or other information about the plan participants may be hosted on the client applications 37.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network 2.

In some embodiments of the invention the one or more users 4 are people within the financial institution that may access the retirement account information and the financial wellness report of the plan participants. In other embodiments of the invention the users 4 are the people within the client institution that may access the retirement account information and the financial wellness report of the plan participants.

As illustrated in FIG. 2, the financial institution systems 10 generally comprise a communication device 12, a processing device 14, and a memory device 16. The processing device 14 is operatively coupled to the communication device 12 and the memory device 16. As used herein, the term “processing device” generally includes circuitry used for implementing the communication and/or logic functions of a particular system. For example, a processing device 14 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 14 may include functionality to operate one or more software programs based on computer-readable instructions 18 thereof, which may be stored in a memory device 16.

The processing device 14 uses the communication device 12 to communicate with the network 2 and other devices on the network 2, such as, but not limited to, the user computer systems 20 and the client systems 30. As such, the communication device 12 generally comprises a modem, server, or other device for communicating with other devices on the network 2.

As further illustrated in FIG. 2, the financial institution systems 10 comprise computer-readable instructions 18 stored in the memory device 16, which in one embodiment includes the computer-readable instructions 18 of a financial plan wellness application 17 (e.g., financial plan wellness tool, or the like) and a wellness segmentation application 15 (e.g., wellness segmentation tool, or the like). In some embodiments, the memory device 16 includes a datastore 19 for storing data related to the financial institution systems 10, including, but not limited to, data created and/or used by the financial wellness plan application 17 or the wellness segmentation application 15.

The financial wellness plan application 17 may be a tool used to provide the user (e.g., the client employee or financial institution employee) with a financial plan wellness report illustrating an overview of the financial wellness (or well-being) of plan participants based on whether or not they are exhibiting behaviors in the retirement account that may lead to retirement planning success. The wellness report may show the trends of wellness scoring for plan participants over time. The wellness report may also include comparisons against the aggregate results of other anonymous plan participants of other anonymous clients. The wellness report may be utilized by the client to guide the client's retirement account objectives. The wellness report and how the scores are calculated within the wellness report are described in further detail below.

The wellness segmentation application 15 may be a tool used to allow a user 4 to create customized wellness segmentation reports in order to segment the wellness metrics of plan participants in one or more retirement accounts into customized groups for additional analysis. The wellness query tool searches the underlying data related to individual wellness scores, wellness metrics, retirement accounts, and participant information, and creates customized wellness segmentation reports for the user 4 based on one or more retirement plans (e.g., within a single institution or between multiple institutions), selection criteria (e.g., wellness scores, behaviors, behavior factors, or the like), and data points selected by the user. In this way, a user may create customized wellness segmentation reports that allow the institution to receive specific information about the participants in order to adjust investment options, retirement account benefits, or targeted communication or education for specifically identified plan participants. The wellness segmentation tool is described in further detail later.

As illustrated in FIG. 2, a user 4 may access the financial wellness application 17 or the wellness segmentation application 15, or receive information (e.g., a wellness report) from the financial wellness application 17 or the wellness segmentation application 15, through a user computer system 20. The user computer system 20 may be a desktop, laptop, tablet, mobile device (e.g., smartphone device), or any other type of computer that generally comprises a communication device 22, a processing device 24, and a memory device 26.

The processing device 24 is operatively coupled to the communication device 22, and the memory device 26. The processing device 24 uses the communication device 22 to communicate with the network 2 and other devices on the network 2, such as, but not limited to, the financial institution systems 10, the client systems 30, and/or other systems. As such, the communication device 22 generally comprises a modem, server, or other device for communicating with other devices on the network 2 and/or a keypad, keyboard, touch-screen, touchpad, microphone, mouse, joystick, other pointer device, button, soft key, and/or other input device(s) for communicating with the user 4.

As illustrated in FIG. 2, the client computer systems 20 may have computer-readable instructions 28 stored in the memory device 26, which in one embodiment includes the computer-readable instructions 28 of a web browser or another application 27 that allows the user 4 to access the financial wellness application 17 or the wellness segmentation application 15, or receive information (e.g., wellness report) from the financial wellness application 17 or the wellness segmentation application 15, or access or received information from other applications, such as the client retirement applications 37, or the like. In some embodiments, the memory device 26 includes a datastore 29 for storing data related to the client computer systems 20, including but not limited to data created and/or used by the web browser/application 27. The web browser/application 27 may be utilized by the user 4 to access the financial wellness application 17 or the wellness segmentation application 15, or receive information from the financial wellness application 17 or the wellness segmentation application 15, to view and/or access a financial plan wellness report or customized wellness report.

As illustrated in FIG. 2, the client systems 30 generally comprise a communication device 32, a processing device 34, and a memory device 36. The processing device 34 is operatively coupled to the communication device 32 and the memory device 36. The processing device 34 uses the communication device 32 to communicate with the network 2 and other devices on the network 2, such as, but not limited to, the user computer systems 20 and the financial institution systems 10. As such, the communication device 32 generally comprises a modem, server, or other device for communicating with other devices on the network 2.

As further illustrated in FIG. 2, the client systems 30 comprise computer-readable instructions 38 stored in the memory device 36, which in one embodiment includes the computer-readable instructions 38 of retirement account applications 37. In some embodiments, the memory device 36 includes a datastore 39 for storing data related to the client systems 30, including but not limited to data created and/or used by the client applications 37.

The client applications 37 may be tools provided to the user 4 to access retirement account applications on the financial institution systems 10 that allow the user 4 to analyze investments, plan for retirement, make investments, allocate investments, or the like. In some embodiments, client applications 37 are the retirement account applications that are hosted by the client system 30, and as such the user 4 may access the client application 37 utilize retirement account applications.

In some embodiments of the invention one or more of the systems may be combined with each other, or otherwise perform the functions of the other system described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application.

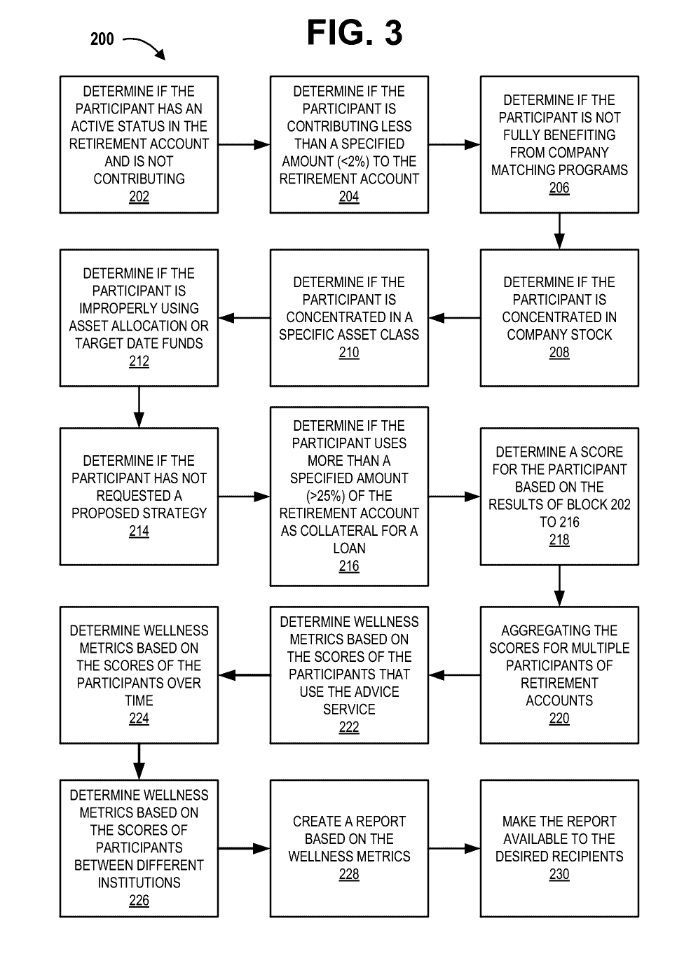

FIG. 3 illustrates a financial plan wellness process 200, in accordance with one embodiment of the invention. In one embodiment of the financial plan wellness process 200 each participant within the plan is given an initial score, and the score is reduced based on how the participant is or is not behaving with respect to how the participant is investing and using the participant's retirement account. For example, in the present invention each participant is given an initial wellness score of ten (10), and the score of ten (10) is potentially reduced based on each participant's behavior and the factors associated with the behavior, as is explained in further detail below. In other embodiments of the invention, other scoring systems may be utilized to score participants based on the participants' behavior. For example, the initial score may be another value, the initial value may be zero and a score may be assigned or added based on the participants' behavior and the associated behavior factors. In still other embodiments of the invention other scoring systems may be utilized that are not specifically outlined herein.

As illustrated by block 202 of FIG. 3, the financial plan wellness tool determines if the participant has an active status in the retirement account and is not currently contributing to the retirement account. This type of account information may illustrate that while a participant has a retirement account, the participant may not be taking advantage of the benefits of the account (e.g., pre-tax savings of a 401K account). Based on this determination a score is adjusted, created, assigned, or the like for this behavior factor. In one embodiment of the present invention, if the participant has an active status and is not contributing to the retirement account two points are subtracted from the wellness score.

Block 204 of FIG. 3 illustrates that the financial plan wellness tool determines if the participant has an active status, is contributing to the retirement account, but is contributing less than a specified amount to the retirement account. Again, this type of account information may illustrate that while a participant is contributing to a retirement account, the participant may not be taking full advantage of the benefits of contributing to the retirement account. Based on this determination a score is adjusted, created, assigned, or the like for this behavior factor. In one embodiment of the present invention, if the participant contributes less than two (2) percent to the retirement account one point is subtracted from the wellness score.

As illustrated by block 206 of FIG. 3, the financial plan wellness tool determines if the participant is not fully benefiting from a retirement matching program. This type of account information may illustrate that while a participant is contributing a significant amount to a retirement account (e.g., 7% of gross salary to a 401K account), the participant may not be taking full advantage of the benefits of the account because a business may match a larger contribution (e.g., employer may match up to 10% of gross salary to a 401K account). Based on this determination a score is adjusted, created, assigned, or the like for this behavior factor. In one embodiment of the present invention, if the participant is not contributing to the retirement account to maximize the amount that the employer matches the contribution of the participant then one point may be subtracted from the wellness score.

The behavior factors determined in blocks 202, 204, and 206 amounts to a participant's savings behavior. Other behavior factors may also be used to determine a participant's savings behavior. Furthermore, since a total of four (4) points may be subtracted from the starting ten (10) points of the wellness score, the participant's savings behavior is weighted as forty (40) percent of the total wellness score. Other weighted values may be used to weight the participant's savings behavior.

As illustrated by block 208 of FIG. 3, the financial plan wellness tool determines if the participant is concentrated in the stock of the institution in which the participant is employed. This type of account information may illustrate that while a participant is investing in company stock the contribution in company stock may not be diversified enough. Based on this determination a score is adjusted, created, assigned, or the like for this behavior factor. In one embodiment of the present invention, if the participant is investing more than twenty (20) percent in the stock of the participant's employer, then two points may be subtracted from the wellness score. In other embodiments, the investment percentage in employer stock may be greater than or less than twenty (20) percent, may be a range of percentages, or may be another threshold range or amount.

Block 210 of FIG. 3 illustrates that the financial plan wellness tool determines if the participant is concentrated in a specific asset class. This type of account information may illustrate that while a participant is investing in different types of investments within an asset class the participant may be too heavily invested in a particular asset class. Based on this determination a score is adjusted, created, assigned, or the like for this behavior factor. In one embodiment of the invention, a specific asset class may be defined as the participant only having two (2) positions or less in specific investment areas, with the exclusion of participants having more than fifty (50) percent in Asset Allocation investments or Target Date investments since these types of investments are in themselves diversified. Alternatively, the participant having more than sixty (60) percent in Large Capitalization investments, more than forty (40) percent in international investments, more than forty (40) percent in Mid or Small Capitalization investments, more than eighty-five (85) percent in Fixed Income, or more than thirty-five (35) percent in Cash. In one embodiment, if the participant is concentrated in a specific asset class one point may be subtracted from the wellness score. In other embodiments, the number of investment positions or investment percentages may be greater than or less than the number of positions or percentages, may be a range of number of positions or percentages, or may be another threshold range or amount.

As illustrated in block 212 of FIG. 3, the financial plan wellness tool determines if the participant is improperly using Asset Allocation or Target Date funds. As described herein Asset Allocation funds are funds that provide a portfolio of fixed or variable mix of stocks, bonds, cash equivalents, or the like. As described herein Target Date funds are aged based funds that provide a fixed or variable mix of stocks, bonds, cash equivalents, or the like. This type of account information may illustrate that while a participant is investing in a fund that is pre-allocated in different assets the participant may be improperly investing in multiple types of pre-allocated funds. Based on this determination a score is adjusted, created, assigned, or the like for this behavior factor. In one embodiment of the present invention, improperly using an Asset Allocation or Target Date funds is having greater than zero (0) but less than one-hundred (100) percent balance in Asset Allocation or Target Date funds, or alternatively, if the participant is invested in more than one Asset Allocation or Target Date funds. In one embodiment, if the participant is improperly using Asset Allocation or Target Date funds one point may be subtracted from the wellness score. In other embodiments of the invention, other ranges or amounts of percentages of investments in Asset Allocation or Target Date funds may be used or multiple investments in these funds may be used to alter the wellness score.

The behavior factors determined in blocks 208, 210, and 212 amounts to a participant's investing behavior. Other behavior factors may also be used to determine a participant's investing behavior. Furthermore, since a total of four (4) points may be subtracted from the starting ten (10) points of the wellness score, the participant's investing behavior is weighted as forty (40) percent of the total wellness score. Other weighted values may be used to weight the participant's investing behavior.

As illustrated by block 214 of FIG. 3, the financial plan wellness tool determines if the participant has not monitored the results of the financial plan for the retirement account. This type of account information may illustrate that while a participant is investing the participant has not inquired about his investments results through an online account interface or through a call center. Based on this determination a score is adjusted, created, assigned, or the like for this behavior factor. In one embodiment, if the participant has not monitored or kept track of his investments one point may be subtracted from the wellness score. In other embodiments, if other monitoring tools are available to the participant the wellness score may be adjusted based on whether or not the participant uses the monitoring tools. The behavior factor determined in block 214 amounts to a participant's setting and monitoring goals behavior. Other behavior factors may also be used to determine a participant's setting and monitoring goals behavior. Furthermore, in the illustrated embodiment since a total of one (1) point may be subtracted from the starting ten (10) points of the wellness score, the participant's setting and monitoring goals behavior is weighted as ten (10) percent of the total wellness score. Other weighted values may be used to weight the participant's setting and monitoring goals behavior.

Block 216 of FIG. 3 illustrates that the financial plan wellness tool determines if the participants use more than a specified amount of the retirement account as collateral for a loan. This type of account information may illustrate that while a participant is investing in a retirement account the participant may be putting the assets in the retirement account at risk. Based on this determination a score is adjusted, created, assigned, or the like for this behavior factor. In one embodiment of the invention if the outstanding loan balance is greater than twenty-five (25) percent or more of the retirement account balance than one (1) point is subtracted from the wellness score. In other embodiments, if the retirement account is used as collateral, if early withdrawals are made from the account, or if the retirement account is used in another way that fails to preserve the retirement account the wellness score may be further adjusted. In other embodiments, the loan balance percentages may be greater than or less than the twenty-five (25) percent, may be a range of percentages, or may be another threshold range or amount. The behavior factor determined in block 216 amounts to a participant's preserving retirement assets behavior. Other behavior factors may also be used to determine a participant's preserving retirement assets behavior. Furthermore, since a total of one (1) point may be subtracted from the starting ten (10) points of the wellness score, the participant's preserving retirement assets behavior is weighted as ten (10) percent of the total wellness score. Other weighted values may be used to weight the participant's preserving retirement assets behavior.

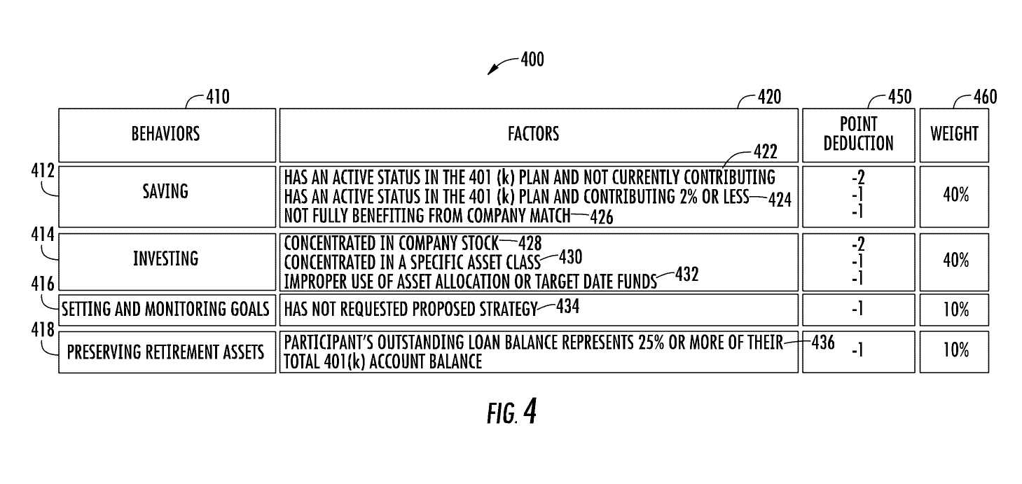

As illustrated by block 218 in FIG. 3, a wellness score is determined based on the behavior factors discussed in blocks 202 through 216. In one embodiment of the invention, the wellness score is based on a scale of ten (10) points. FIG. 4 illustrates a wellness scoring table 400 that lists the behaviors 410 (e.g., savings 412, investing 414, setting and monitoring goals 416, and preserving retirement assets 418) and the behavior factors 420 associated with each of the behaviors 410. The wellness scoring table 400 also illustrates the point deductions 450 for each of the behavior factors 420, and weighted values 460 for each of the behaviors 410. In one embodiment of the invention a participant is considered to have a financial plan that is “well” or “sound” if the participant has a financial plan wellness score of greater than or equal to seven (7). In other embodiments of the invention another threshold, a range of thresholds, or another wellness determination score may be set.

In block 220 illustrated in FIG. 3, the financial plan wellness tool aggregates the wellness scores for multiple participants in one or more retirement accounts for one or more institutions. Block 222 of FIG. 3 illustrates that the financial plan wellness tool determines wellness metrics based on the wellness scores of aggregated plan participants that utilize an advice service versus aggregated plan participants that do not utilize an advice service. As illustrated in block 224, the financial plan wellness tool determines wellness metrics based on changes in wellness scores of aggregated plan participants over a period of time. As further illustrated in block 226, the financial plan wellness tool determines wellness metrics based on the scores of aggregated plan participants in retirement accounts between different institutions. Block 228 of FIG. 3 illustrates that the financial plan wellness tool creates a report based on the wellness metrics identified in block 220 to block 226. In still other embodiments, the wellness metrics may also be broken down by the age of the plan participants, or other like plan participant information. As illustrated in block 230 the financial plan wellness tool makes the report available to the desired recipients, for example, the employees at the client or the participants in retirement account. The wellness metrics determined and illustrated in the report are described in further detail with respect to the report illustrated in FIGS. 5 through 11.

FIGS. 5 through 11 illustrates the wellness report 300 created by the financial plan wellness tool. In one embodiment of the invention the wellness report 300 may be in paper, electronic, or another form and may be electronically provided or displayed to the user 4. In the present invention the wellness report 300 is an electronic copy that is sent to a user 4 at the client to illustrate the wellness of the participants employed by the client that participant in the client's 401K retirement plan.

FIG. 5 illustrates a financial wellness overview section 500 of the wellness report 300. The financial wellness overview section 500 illustrates a participant wellness overview section 510 and a participant wellness score overview 520. The participant wellness overview section 510 illustrates a graphical representation 512, numerical representation 514, and raw number representation 516 of wellness metrics for the client. As illustrated in the participant wellness overview section 510 the financial plan wellness tool illustrates that eighty-three (83) percent of the participants in the client's 401K plan are considered to have a well or sound financial plan, while seventeen (17) percent of the participants are considered to have an unwell or unsound financial plan. The participant wellness overview section 510 also illustrates that out of all of the employees of the client eighty-eight (88) percent participate in the client's 401K plan, and twenty (20) percent of the eighty-eight (88) percent subscribe to receiving an advice service that provides advice to the participant regarding the participant's financial plan. The advice service provides, among other things, how the participant should allocate the money in the participant's retirement account. In addition, the participant wellness overview section 510 also illustrates the average overall wellness score (e.g., 7.7) for all of the participants that participate in the client's 401K plan.

The participant wellness score overview section 520 illustrates the behaviors 522, the behavior factors 524, a weight percentage 526 of the behaviors 522, and scoring 528 of the behavior factors 524. The determination of how the wellness score is calculated was previously described in further detail above with respect to FIGS. 3 and 4 above.

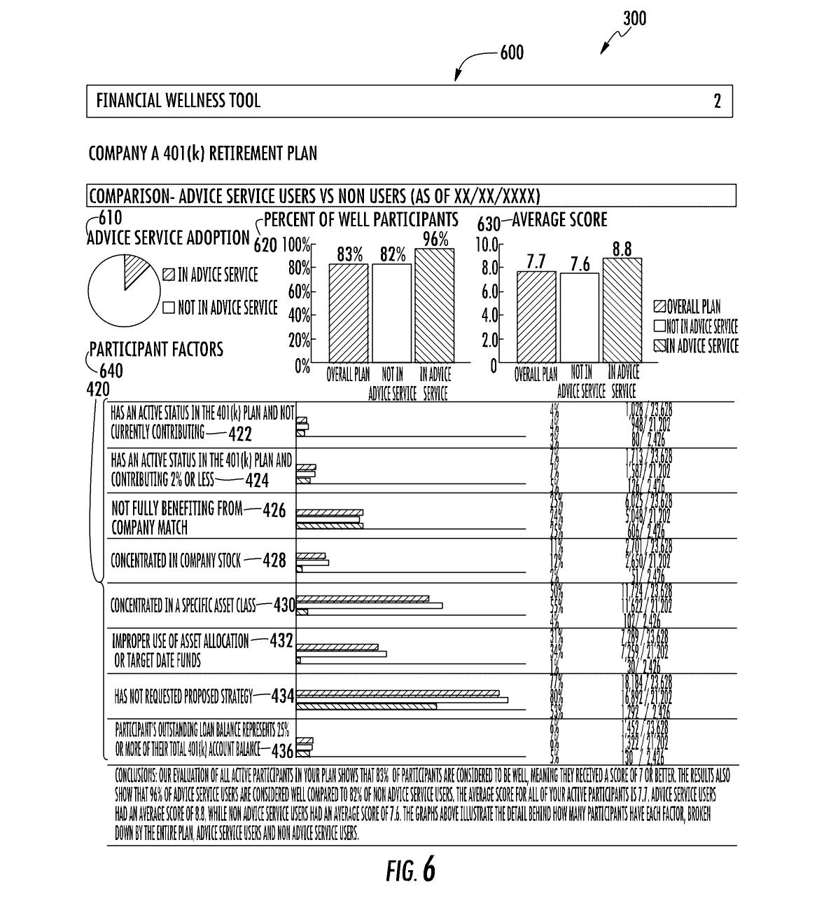

FIG. 6 illustrates an advice service user comparison section 600 of the wellness report 300. The advice service user comparison section 600 illustrates an advice service adoption section 610, a percent of well participants section 620, an average score section 630, and a participant factors section 640. As illustrated in FIG. 6, the advice service adoption section 610 illustrates graphically and numerically the percentage or the number of participants that utilize the advice service verses the percentage or the number of participants that do not utilize the advice service. As further illustrated in FIG. 6, the percent of well participants section 620 illustrates graphically and numerically the percent of participants that are considered well in the overall plan, are well and utilize the advice service, and are well and do not utilize the advice service. As further illustrated in FIG. 6, the average score section 630 illustrates graphically and numerically the average wellness scores for participants in the overall plan, for participants that utilize the advice service, and for participants that do not utilize the advice service. The participant factors section 640 illustrates graphically and numerically the scoring, in percentage and raw number format, of participants in the overall plan that utilize the advice service, and that do not use the advice service broken down by the individual behavior factors 420. For example, as illustrated by the participant factors section 640 most of the participants wellness scores from Company A are reduced as a result of the participants being concentrated in a specific asset class 430 and not requesting a proposed financial plan strategy 434.

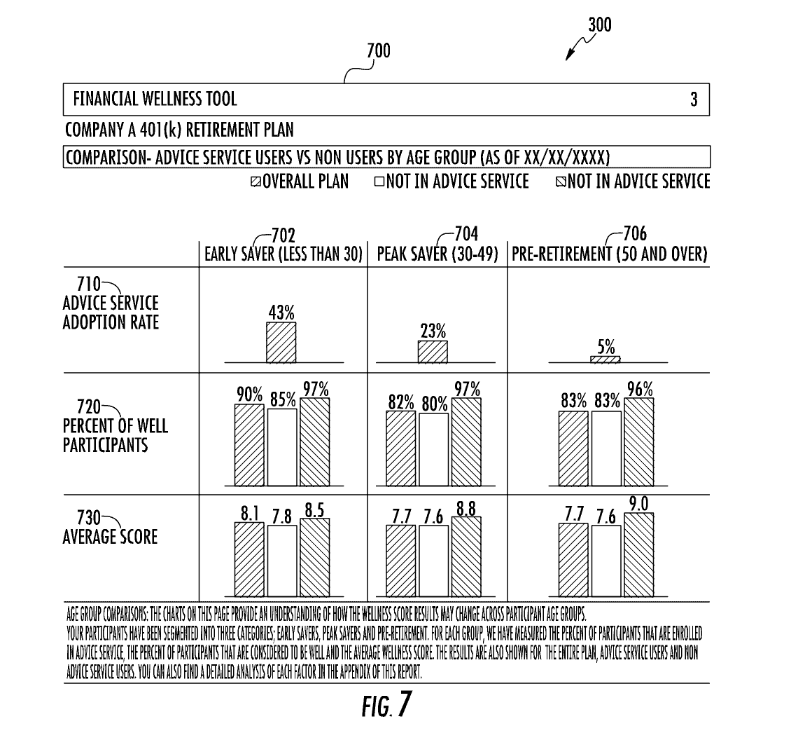

FIG. 7 illustrates an advice service user age comparison section 700 of the wellness report 300. The advice service user age comparison section 700 illustrates graphically and numerically the advice service adoption rate 710, the percent of well participants 720, and the average score 730 of the participants based on the ages of the participants. In one embodiment of the invention, the ages are broken down to early savers 702 (e.g., less than 30 years of age), peak savers 704 (e.g., between 30-49 years of age), and pre-retirement savers 706 (e.g., over 50 years old). The illustrated embodiment indicates that more of the younger savers subscribe to the advice service than older savers, and that no matter what the age of the participants, the participants are well (i.e., sound) and have a better wellness score if they subscribe to the advice service. In other embodiments of the invention the wellness metrics may be broken down by different age groups, additional age groups, or the like.

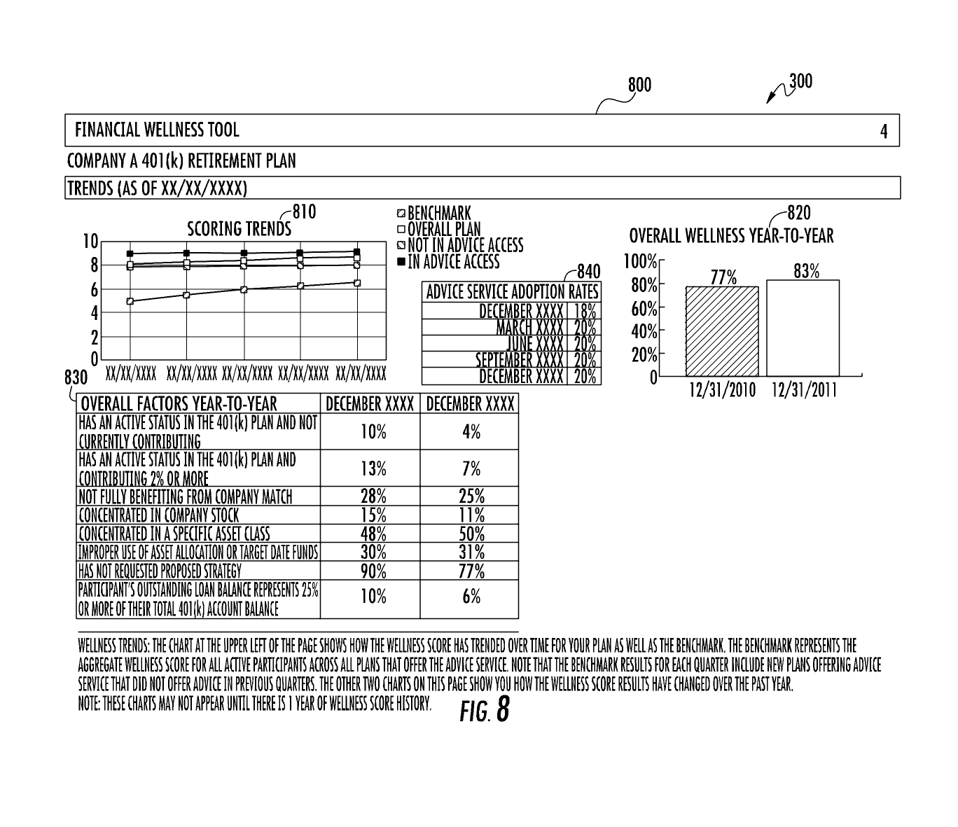

FIG. 8 illustrates a trends section 800 of the wellness report 300. The trends section 800 illustrates wellness metrics over a period of time, and includes a scoring trends section 810, an overall wellness year-to-year section 820, an overall factors year-to-year section 830, and an advice service adoption rate section 840. As illustrated in FIG. 8 the scoring trends section 810 graphically and numerically illustrates how the wellness scores for participants of an institution have changed over time based on an average benchmark wellness score (e.g., combination of all participants in all institutions that use the advice service), an overall plan score for the client, a not utilizing the advice service score, and a utilizing the advice service score. The overall wellness year-to-year section 820 illustrates graphically and numerically the overall wellness score for participants of in the client's 401K plan on a year over year basis. The overall factors year-to-year section 830 illustrates numerically (and it can be graphically) the number of participants (e.g., percentage based) that meet the behavior factors 420 on a year over year basis. The advice service adoption rates section 840 illustrates the number of participants that utilize the advice service changes over each quarter of the year. In other embodiments other time periods may be utilized to illustrate trends in the wellness metrics over a period of time. In some embodiments, the trends section 800 may only appear in the wellness report after the client has accrued at least a year's worth of data.

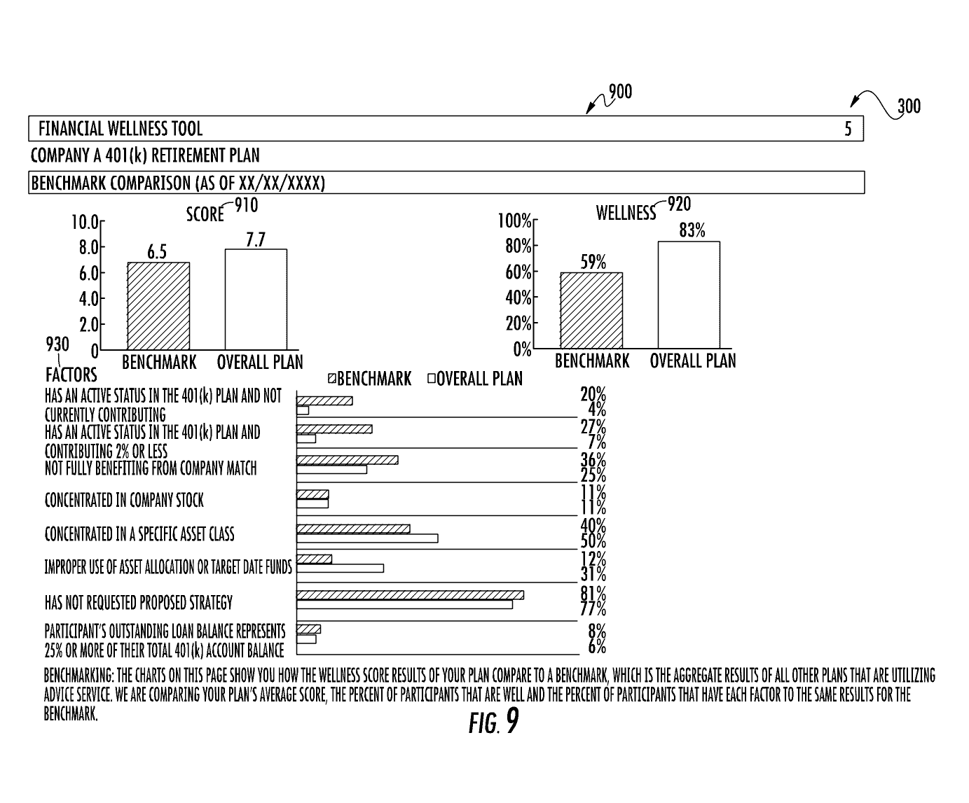

FIG. 9 illustrates a benchmark comparison section 900 of the wellness report 300. The benchmark comparison section 900 illustrates how the wellness score metrics of a client compare with a benchmark, which may be the aggregate results of one, some, or all other retirement plans that are utilizing the financial wellness tool and/or the advice service product. The benchmark comparison section 900 has a benchmark score section 910, a benchmark wellness section 920, and a benchmark factors section 930. The benchmark score section 910 illustrates graphically and numerically the average scores for participants across various clients and the average score for the participants in Company A. The benchmark wellness section 920 illustrates graphically and numerically the percentage of participants that are considered well for the 401K plans of multiple, or all, clients in comparison to the percentage of participants that are considered well in the 401K plan of Company A. The benchmark factors section 930 illustrates graphically and numerically a benchmark of participants in the 401K plans of multiple, or all, clients, versus the participants in the 401K plan of Company A, broken down into the behavior factor 420 scores that used to determine the wellness score. For example, as illustrated in FIG. 9 the participants in Company A's plan outperform the benchmark (e.g., average of participants in other companies) in all behavior categories except that more of Company A's participants are concentrated in specific asset classes and improperly use asset allocation and/or target date funds. Company A may use this information to improve targeted communications to the participants to improve the investing behaviors 414 of Company A's participants.

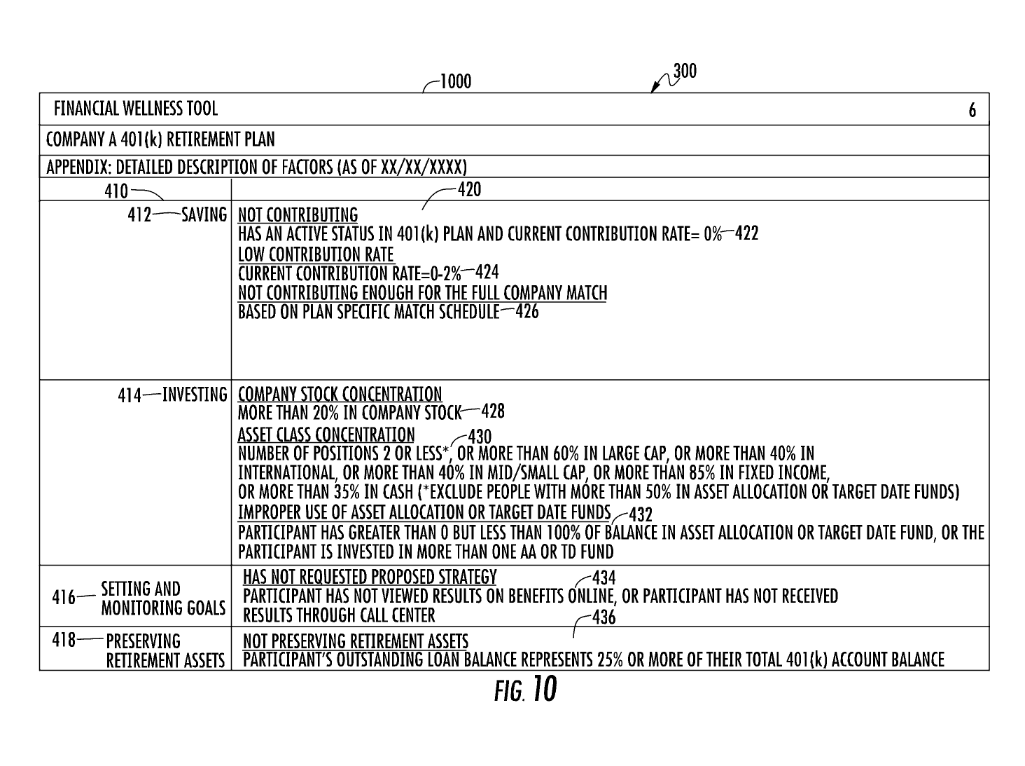

FIG. 10 illustrates an appendix in the wellness report 300 that has a description of the factors section 1000 that illustrates how the behavior factors 420 are scored, which has been previously discussed in detail above with respect to FIGS. 3 and 4.

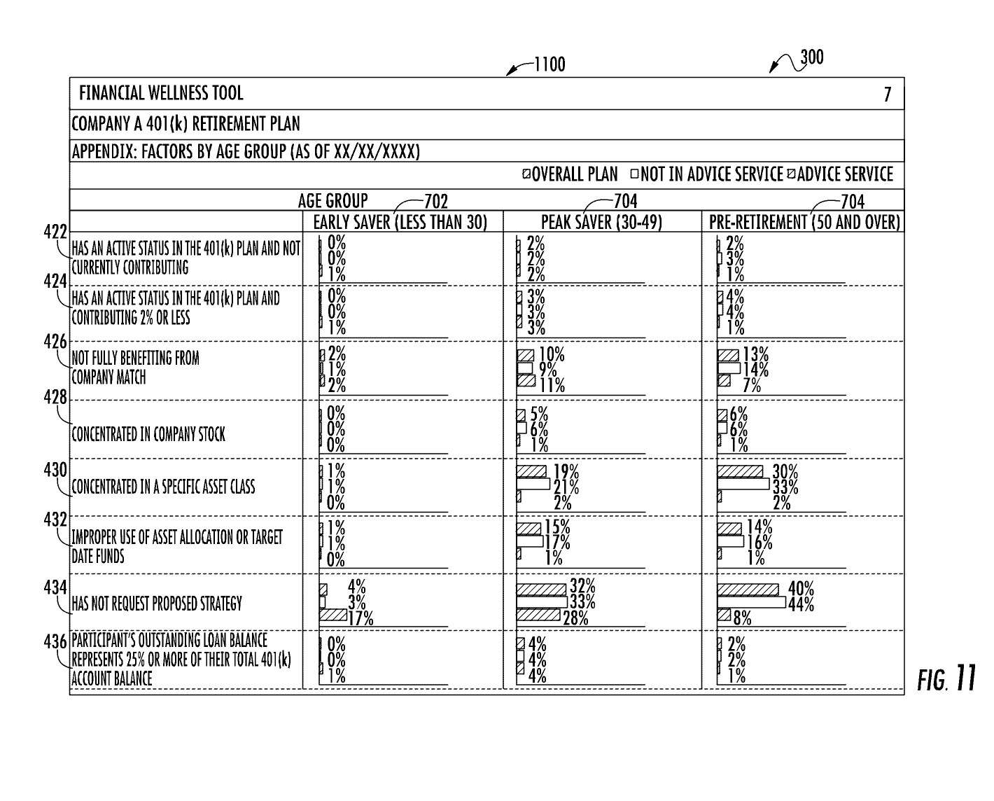

FIG. 11 illustrates, in an appendix of the wellness report 300, an age group section 410. The age group section 410 provides a breakdown of all of the participants in client's retirement account based on the behavior factors 420, age groups, and advice service participation. As illustrated in FIG. 11, the number of participants that apply to each of the behavior factors 420 are illustrated graphically and numerically based on the participants in overall plan, the number of participants that do not utilize the advice service, and the number of participants that do utilize the advice service. The behavior factors 420 are further split into age groups that are broken down to early savers 702 (e.g., less than 30 years of age), peak savers 704 (e.g., between 30-49 years of age), and pre-retirement savers 706 (e.g., over 50 years old). In other embodiments of the invention, the wellness metrics may be broken down by different age groups, additional age groups, or the like.

In some embodiments of the invention the financial plan wellness tool includes a wellness query tool that allows the user 4 to create customized wellness segmentation reports in order to segment the wellness metrics of plan participants in a retirement account into customized groups for additional analysis. The wellness query tool searches the underlying data related to individual wellness metrics, retirement accounts, and participant information, and creates a customized wellness segmentation report for the user 4 based on one or more plans, selection criteria (e.g., wellness scores, behaviors 410, behavior factors 420, or the like), and data points selected by the user 4, all of which are described in further detail below.

FIG. 12 illustrates a wellness query tool process 1200, in accordance with one embodiment of the invention, which utilizes a wellness segmentation application 15 (e.g., wellness segmentation tool, or wellness query tool) to allow a user 4 to create customized wellness segmentation reports in order to segment the wellness metrics of plan participants in one or more retirement accounts into customized groups for additional analysis.

As illustrated in block 1202 of FIG. 12, the financial institution system 10 receives a request from a user to access the wellness query tool. In response, the financial institution system 10 authenticates the user as being authorized to access the query tool for the retirement account information of an institution, as illustrated by block 1204 of FIG. 12. Block 1206 of FIG. 12 illustrates that the wellness query tool provides a query interface 1300 to the user 4 for creating the customized wellness segmentation reports by allowing the user 4 to identify specific retirement plans through a plan selector.

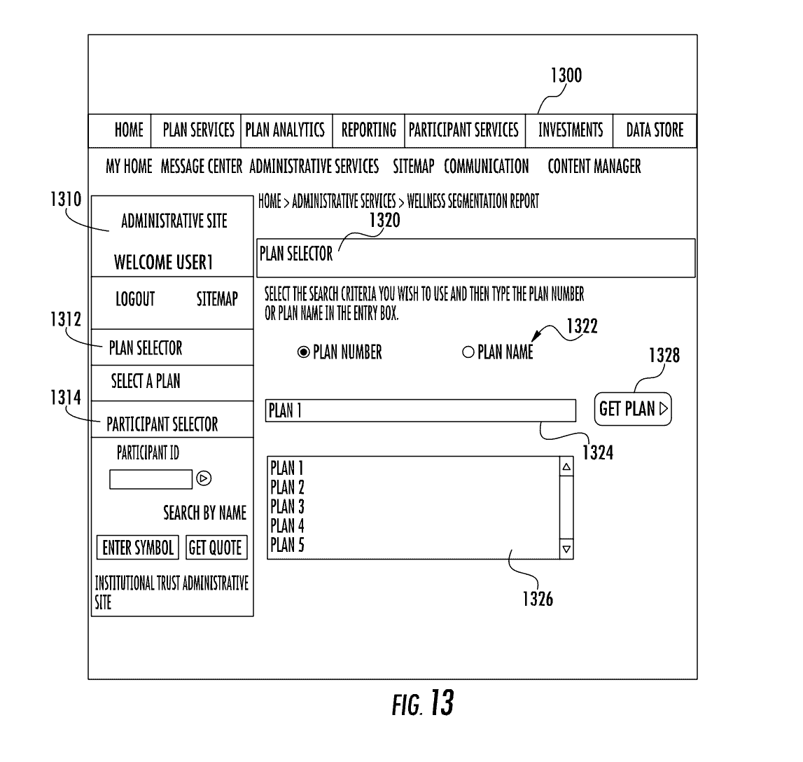

FIG. 13 illustrates one embodiment of the query interface 1300. The query interface 1300 may include an overview section 1310 and a plan selector section 1320. The overview section 1310 may include a plan selector link 1312, and a participant selector link 1314. The plan selector link 1312 allows a user to create reports based on different plans, while the participant selector link 1314 allows a user to search for a specific plan participants within a retirement plan using a participant identification number (e.g., social security number, account number, or the like). These links allow the user to create the customized wellness report and to identify specific information about a plan participant, as explained in further detail below.

The plan selector section 1320 allows a user to search for plan participants within a specific retirement account plan using either the plan name or a plan number. For example, an institution may have multiple types of retirement plans for their employees (e.g. different plans for different businesses), or an institution may manage multiple plans for different client institutions. Therefore, the user 4 may utilize the plan selector section 1320 to narrow the customized wellness report to query only the information for participants in one or more specific plans. As illustrated by block 1208 the wellness query tool may receive a request from a user 4 to search for plans by receiving a plan type 1322 (e.g., either a plan number or a plan name) and a plan search query 1324. Thereafter, the wellness query tool provides the plans that match the plan search query in a plan search results section 1326, as illustrated by block 1210 in FIG. 12.

As illustrated by block 1212 of FIG. 12, the wellness query tool receives a selection from the user 4 of one or more of the plans in the plan search results section 1326 in order to limit the customized wellness report to only the participants of the selected plans. The user 4 may select the get plan link 1328 in order to proceed with creating the customized wellness segmentation report.

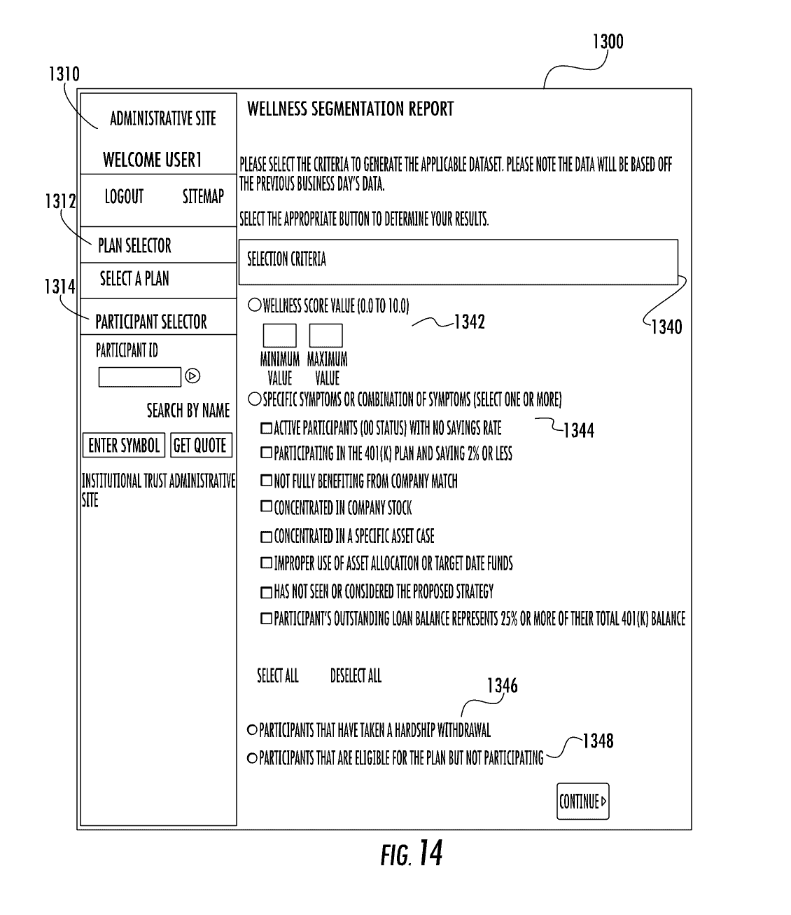

As illustrated in block 1214 of FIG. 12, the wellness query tool provides the user 4 with a selection criteria section 1340 in the query interface 1300, which is illustrated in FIG. 14. The selection criteria section 1340 allows a user to select specific participant related criteria from which to create the customized wellness segmentation report. The user 4 may limit the customized wellness segmentation report to participants that have a specific wellness score or a range of wellness scores, as illustrated by the wellness criteria 1342. The user 4 may also limit the customized wellness segmentation report to participants that meet one or more of the behaviors 410 or behavior factors 420, as illustrated by the behavior factor criteria 1344. The user 4 may further limit the customized wellness segmentation report to participants that have taken a hardship withdrawal, as illustrated by the hardship criteria 1346, or to participants that are eligible for the plan but are not participating, as illustrated by the eligibility criteria 1348. As illustrated by block 1216 in FIG. 12, the wellness query tool receives a request from the user 4 to limit the customized wellness report to participants that meet one or more of the wellness criteria 1342, behavior factors criteria 1344, hardship criteria 1346, and/or eligibility criteria 1328.

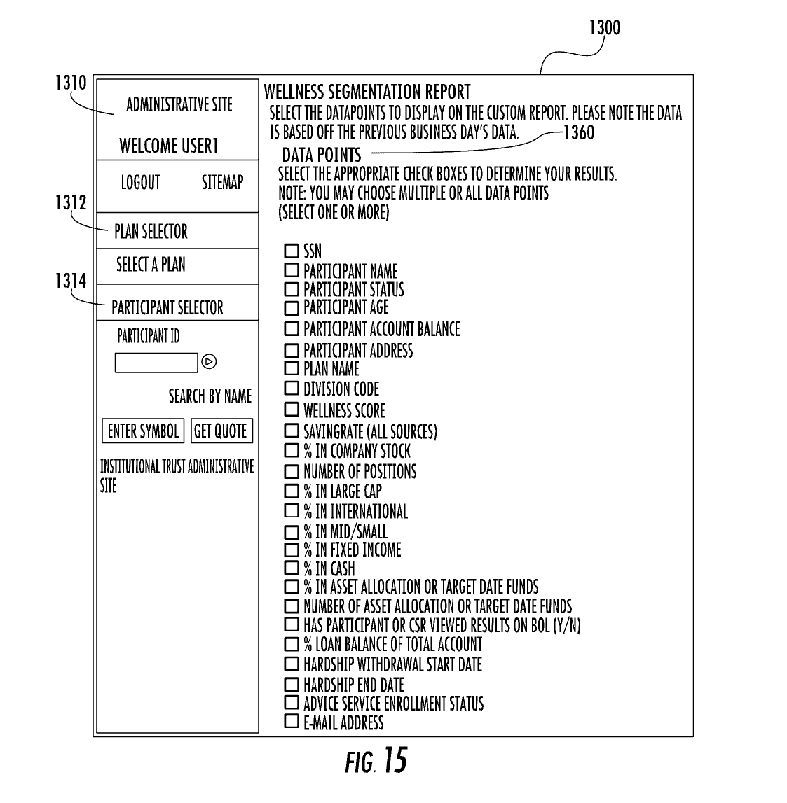

As illustrated by block 1218, the wellness query tool also provides a data point section 1360 to the user 4 in the query interface 1300, which is illustrated in FIG. 15. FIG. 15 illustrates one embodiment of the data point section 1360, which allows a user 4 select the specific information that the user 4 wants to include in a customized wellness segmentation report. The data points include information about the participants, account information about the retirement accounts of the participants, or other like information. In some embodiments of the invention the data points may include the social security number of the participant, participant name, participant status, participant age, participant account balance, participant address, plan name, division code, wellness score, saving rate, percent in company stock, number of investment positions, percent in large capitalization stock, percent in international investments, percent in mid or small capitalization stock, percent in fixed income, percent in cash, percent in asset allocation or target date funds, number of asset allocation or target date funds, an indication that the participant or a representative has viewed investment results, percent loan balance of total account, hardship withdrawal start date, hardship end date, advice service enrollment status, participant e-mail address, or other like information. The customized wellness report may include one or more of the data points related to the same information that is described as being in the financial plan wellness report, participant account information (e.g., investment percentages, balances, behaviors, behavior factors, or the like), or plan participant information (e.g., identification number, name, status, address, e-mail, phone number, geographic location, or other like information), as well as other types of information not specifically outlined as data points.

As illustrated by block 1220 of FIG. 12, the wellness query tool receives a request from a user 4 to limit the customized wellness segmentation report to specific data points in which the user 4 is interested. Block 1222 of FIG. 12 illustrates that the wellness query tool creates the customized wellness segmentation report based on the plan selection, the criteria selection, and the data point selection made by the user 4. As illustrated by block 1224 of FIG. 12, the wellness query tool provides the customized wellness segmentation report to the user 4. The customized report may be provided to the user 4 in the same way as described with respect to the wellness report.

As an example of the use of the wellness query tool, as illustrated by the financial wellness report interface in FIG. 6, there are 1,028 participants that have an active status in the retirement plan, but are not currently contributing. A user 4 in the institution employing the 1,028 participants may want to view additional information about these participants by selecting the plan in which the participants belong using the plan selector section 1320. The user 4 may then select the “active participants with no savings rate” criteria in the selection criteria section 1340 to access information about the 1,028 participants that meet this behavior according to the wellness report illustrated in FIG. 6. The user 4 may then select the participants name, wellness score, account balance, and percentage investments in large cap, mid/small cap, fixed income, and cash in order to view information for these specific data points for the 1,028 participants that meet the particular behavior factor selected. In this way, a user 4 at the institution that employs the participants, or a user 4 at the institution that manages the retirement accounts for the participants, may create customized wellness segmentation reports that allow the institution to receive specific information about the participants in order to adjust investment options, retirement account benefits, or targeted communication or education for specifically identified plan participants. For example, the institution may be able it determine that some of the 1,028 participants that are not contributing to the retirement plan have a large percentage of retirement holdings in cash, and thus, provide targeted communication to the participants for investment advice for the cash holdings, as well as material related to making contributions to the retirement plan.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

U.S. patent application Ser. No. ______ to Brown, entitled “System for Customizing Resource Allocation Assessments and Electronic Communication,” and filed concurrently herewith, describes the use of a tool to create customized reports and is hereby incorporated by reference in its entirety.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A system for allowing a client to identify, monitor, and track the use and allocation of resources of plan participants of the client by calculating a wellness score for the plan participants, the system comprising:
at least one memory device having computer readable program code store thereon; and
at least one processing device operatively coupled to the at least one memory device, wherein the at least one processing device is configured to execute the computer readable program code to:
receive a request from a user to access retirement account information for plan participants in a retirement account at the client, wherein the request is received from a user computer system;
authenticate the user for access to the retirement account information;
electronically identify, automatically, the retirement account information for the plan participants in the retirement account by accessing account information through a network of client systems, wherein the retirement account information is related to savings, investing, setting and monitoring goals, and account preservation behaviors of the plan participants, and wherein the retirement information is identified without the plan participants providing any of the retirement account information;
electronically determine, automatically, a savings score from the savings behavior, wherein the savings score is determined based on behavior factors relating to:
a determination if the plan participants have an active status in the retirement account and are not contributing to the retirement account and transforming this determination into an active status score,
a determination if the plan participants are contributing less than a contribution percentage and transforming this determination into a contribution percentage score,
a determination if the plan participants are not achieving the maximum benefit of contribution matching from the client and transforming this determination into a contribution matching score, and
transforming the active status score, the contribution percentage score, and the contribution matching score into the savings score;
electronically determine, automatically, an investing score from the investing behavior, wherein the investing score is determined based on behavior factors relating to:
a determination if the plan participants are concentrated in the client stock and transforming this determination into a client stock concentration score,
a determination if the plan participants are concentrated in a specific asset class and transforming this determination into an asset class concentration score,
a determination if the plan participants are improperly using predefined diversified retirement allocation and transforming this determination into a retirement allocation score, and
transforming the client stock concentration score, the asset class concentration score, and the retirement allocation score into the investing score;
electronically determine, automatically, a setting and monitoring goals score, wherein the setting and monitoring goals score is determined based on a behavior factor related to a determination of if the plan participants have requested an investment strategy and transforming this determination into the setting an monitoring goals score;
electronically determine, automatically, an account preservation score, wherein the account preservation score is determined based on a behavior factor related to a determination of if the plan participants are using a specified value of the retirement account balance as collateral for a loan and transforming this determination into the account preservation score;
electronically determine, automatically, a wellness score for the plan participants in the retirement account for the client based on a combination of the savings score, the investing score, the setting and monitoring goals score, and the account preservation score;
electronically determine, automatically, customized wellness metrics for the plan participants, wherein the wellness metrics reflect the wellness scores or the behaviors of the plan participants in one or more aggregate metrics verses the wellness scores or the behaviors of the plan participants from at least one of other clients;
create a report that is customized illustrating the wellness scores for the plan participants and the wellness metrics for the plan participants at the client verses the wellness scores for the plan participants and the wellness metrics for the plan participants at the at least one of the other clients; and
provide the report to the client for analyzing the wellness of the plan participants of the client, wherein the report is sent to the client through the client systems.

2. The system of claim 1, wherein the savings behavior factor for the determination if the plan participants have an active status in the retirement account and are not contributing to the retirement account and the investing behavior factor for the determination if the plan participants are concentrated in the client stock have a greater contribution to the wellness score than the other behavior factors.

3. The system of claim 1, wherein the at least one processing device is configured to execute the computer readable program code to:
electronically determine, automatically, benchmark wellness scores and benchmark wellness metrics, wherein the benchmark wellness scores and the benchmark wellness metrics are associated with other plan participants from the at least one of the other clients, and wherein the report comprises a comparison illustrating the wellness scores for the plan participants and the wellness metrics for the plan participants versus the benchmark wellness scores and the benchmark wellness metrics of the other plan participants from the at least one of the other clients.

4. The system of claim 1, wherein the report comprises a wellness overview section, an advice service user comparison section, an advice service user age comparison section, and a trends section.

5. The system of claim 1, wherein the report is utilized by the client to improve targeted communications to the plan participants to improve the investing behaviors of the plan participants of the client.

6. The system of claim 1, wherein the wellness metrics for the plan participants are broken down into the plan participants that utilize an advice service and the plan participants that fail to use the advice service.

7. The system of claim 1, wherein the wellness metrics for the plan participants are broken down into age groups of the plan participants.

8. The system of claim 1, wherein the wellness metrics for the plan participants are broken down as the wellness scores change over time; and in comparison with the wellness scores of other plan participants at the at least one of the other clients.

9. A computer program product for allowing a client to identify, monitor, and track the use and allocation of resources of plan participants of the client by calculating a wellness score for the plan participants, the computer program product comprising at least one non-transitory computer-readable medium having computer-readable program code portions embodied therein, the computer-readable program code portions comprising:
an executable portion configured to receive a request from a user to access retirement account information for plan participants in a retirement account at the client, wherein the request is received from a user computer system;
an executable portion configured to authenticate the user for access to the retirement account information;
an executable portion configured to electronically identify, automatically, the retirement account information for the plan participants in the retirement account by accessing account information through a network of client systems, wherein the retirement account information is related to savings, investing, setting and monitoring goals, and account preservation behaviors of the plan participants, and wherein the retirement information is identified without the plan participants providing any of the retirement account information;
an executable portion configured to electronically determine, automatically, a savings score from the savings behavior, wherein the savings score is determined based on behavior factors relating to:
a determination if the plan participants have an active status in the retirement account and are not contributing to the retirement account and transforming this determination into an active status score,
a determination if the plan participants are contributing less than a contribution percentage and transforming this determination into a contribution percentage score,
a determination if the plan participants are not achieving the maximum benefit of contribution matching from the client and transforming this determination into a contribution matching score, and
transforming the active status score, the contribution percentage score, and the contribution matching score into the savings score;
an executable portion configured to electronically determine, automatically, an investing score from the investing behavior, wherein the investing score is determined based on behavior factors relating to:
a determination if the plan participants are concentrated in the client stock and transforming this determination into a client stock concentration score,
a determination if the plan participants are concentrated in a specific asset class and transforming this determination into an asset class concentration score,
a determination if the plan participants are improperly using predefined diversified retirement allocation and transforming this determination into a retirement allocation score, and
transforming the client stock concentration score, the asset class concentration score, and the retirement allocation score into the investing score;
an executable portion configured to electronically determine, automatically, a setting and monitoring goals score, wherein the setting and monitoring goals score is determined based on a behavior factor related to a determination of if the plan participants have requested an investment strategy and transforming this determination into the setting an monitoring goals score;
an executable portion configured to electronically determine, automatically, an account preservation score, wherein the account preservation score is determined based on a behavior factor related to a determination of if the plan participants are using a specified value of the retirement account balance as collateral for a loan and transforming this determination into the account preservation score;
an executable portion configured to electronically determine, automatically, a wellness score for the plan participants in the retirement account for the client based on a combination of the savings score, the investing score, the setting and monitoring goals score, and the account preservation score;
an executable portion configured to electronically determine, automatically, customized wellness metrics for the plan participants, wherein the wellness metrics reflect the wellness scores or the behaviors of the plan participants in one or more aggregate metrics verses the wellness scores or the behaviors of the plan participants from at least one of other clients;
an executable portion configured to create a report that is customized illustrating the wellness scores for the plan participants and the wellness metrics for the plan participants at the clients verses the wellness scores for the plan participants and the wellness metrics for the plan participants at the at least one of the other clients; and
an executable portion configured to provide the report to the client for analyzing the wellness of the plan participants of the client, wherein the report is sent to the client through the client systems.

10. The computer program product of claim 9, wherein the savings behavior factor for the determination if the plan participants have an active status in the retirement account and are not contributing to the retirement account and the investing behavior factor for the determination if the plan participants are concentrated in the client stock have a greater contribution to the wellness score than the other behavior factors.

11. The computer program product of claim 9, wherein the computer-readable program code portions further comprise:
an executable portion to electronically determine, automatically, benchmark wellness scores and benchmark wellness metrics, wherein the benchmark wellness scores and the benchmark wellness metrics are associated with other plan participants from the at least one of the other clients, and wherein the report comprises a comparison illustrating the wellness scores for the plan participants and the wellness metrics for the plan participants versus the benchmark wellness scores and the benchmark wellness metrics of the other plan participants from the at least one of the other clients.

12. The computer program product of claim 9, wherein the report comprises a wellness overview section, an advice service user comparison section, an advice service user age comparison section, and a trends section.

13. The computer program product of claim 9, wherein the report is utilized by the client to improve targeted communications to the plan participants to improve the investing behaviors of the plan participants of the client.

14. The computer program product of claim 9, wherein the wellness metrics for the plan participants are broken down into the plan participants that utilize an advice service and the plan participants that fail to use the advice service.

15. The computer program product of claim 9, wherein the wellness metrics for the plan participants are broken down into age groups of the plan participants.

16. The computer program product of claim 9, wherein the wellness metrics for the plan participants are broken down as the wellness scores change over time, and in comparison with the wellness scores of other plan participants at the at least one of the other clients.

17. A computer implemented method for allowing a client to identify, monitor, and track the use and allocation of resources of plan participants of the client by calculating a wellness score for the plan participants, the computer implemented method comprising:
receiving, by at least one processing device a request from a user to access retirement account information for plan participants in a retirement account at the client, wherein the request is received from a user computer system;
authenticating, by the at least one processing device, the user for access to the retirement account information;
electronically identifying, automatically by the at least one processing device, retirement account information for the plan participants in the retirement account by accessing account information through a network of client systems, wherein the retirement account information is related to savings, investing, setting and monitoring goals, and account preservation behaviors of the plan participants, and wherein the retirement information is identified without the plan participants providing any of the retirement account information;
electronically determining, automatically by at least one processing device, a savings score from the savings behavior, wherein the savings score is determined based on behavior factors relating to:
a determination if the plan participants have an active status in the retirement account and are not contributing to the retirement account and transforming this determination into an active status score,
a determination if the plan participants are contributing less than a contribution percentage and transforming this determination into a contribution percentage score,
a determination if the plan participants are not achieving the maximum benefit of contribution matching from the client and transforming this determination into a contribution matching score, and
transforming the active status score, the contribution percentage score, and the contribution matching score into the savings score;
electronically determining, automatically by at least one processing device, an investing score from the investing behavior, wherein the investing score is determined based on behavior factors relating to:
a determination if the plan participants are concentrated in the client stock and transforming this determination into a client stock concentration score,
a determination if the plan participants are concentrated in a specific asset class and transforming this determination into an asset class concentration score,
a determination if the plan participants are improperly using predefined diversified retirement allocation and transforming this determination into a retirement allocation score, and
transforming the client stock concentration score, the asset class concentration score, and the retirement allocation score into the investing score;
electronically determining, automatically by at least one processing device, a setting and monitoring goals score, wherein the setting and monitoring goals score is determined based on a behavior factor related to a determination of if the plan participants have requested an investment strategy and transforming this determination into the setting an monitoring goals score;
electronically determining, automatically by at least one processing device, an account preservation score, wherein the account preservation score is determined based on a behavior factor related to a determination of if the plan participants are using a specified value of the retirement account balance as collateral for a loan and transforming this determination into the account preservation score;
electronically determining, automatically by at least one processing device, a wellness score for the plan participants in the retirement account for the client based on a combination of the savings score, the investing score, the setting and monitoring goals score, and the account preservation score;
electronically determining, automatically by the processing device, customized wellness metrics for the plan participants, wherein the wellness metrics reflect the wellness scores or behaviors of the plan participants in one or more aggregate metrics verses the wellness scores or the behaviors of the plan participants from at least one of other clients;
creating, by the processing device, a report that is customized illustrating the wellness scores for the plan participants and the wellness metrics for the plan participants at the client verses the wellness scores for the plan participants and the wellness metrics for the plan participants at the at least one of the other clients; and
providing the report to the client for analyzing the wellness of the plan participants of the client, wherein the report is sent to the client through the client systems.

18. The computer implemented method of claim 17, wherein the computer implemented method further comprises:
electronically determining, automatically by at least one processing device, benchmark wellness scores and benchmark wellness metrics, wherein the benchmark wellness scores and the benchmark wellness metrics are associated with other plan participants from the at least one of the other clients, and wherein the report comprises a comparison illustrating the wellness scores for the plan participants and the wellness metrics for the plan participants versus the benchmark wellness scores and the benchmark wellness metrics of the other plan participants from the at least one of the other clients.

19. The computer implemented method of claim 17, wherein the wellness metrics comprise aggregate metrics for the plan participants that are broken down into the plan participants that utilize an advice service and the plan participants that fail to use the advice service; aggregate metrics that are broken down into age groups of the plan participants; aggregate metrics that are broken down as the wellness scores change over time; and aggregate metrics that are broken down in comparison with the wellness scores of other plan participants at other clients.

20. The computer implemented method of claim 17, wherein the wellness score is based on an initial value of ten points and the points are subtracted from the initial value based on the behavioral factors of the plan participants determined from the retirement account information.
